(19) United States
(12) Patent Application Publication
(10) Pub. No.: US 2025/0358433 A1
(43) Pub. Date: Nov. 20, 2025

(54) OPTIMAL RESOLUTION SELECTION FOR A VIDEO STREAM

(71) Applicant: Microsoft Technology Licensing, LLC, Redmond, WA (US)

(72) Inventors: Vishnu Sandeep NALLURI, Bellevue, WA (US); Karen Master Ben-Dor, Kfar Saba (IL); Stav Yagev, Tel Aviv (IL); Raz HALALY, Herzliya (IL); Tamir SHLOMI, Hadera (IL); Moshe David, Givataim (IL); Aviv Hurvitz, Herzliya (IL); Eshchar ZYCHLINSKI, Tel Aviv (IL)

(21) Appl. No.: 18/669,195

(22) Filed: May 20, 2024

(51) Int. Cl. H04N 19/20; G06V 10/82; G06V 40/16; H04N 19/136; H04N 19/42

(52) U.S. Cl. CPC H04N 19/20; G06V 10/82; G06V 40/161; H04N 19/136; H04N 19/42

(57) ABSTRACT

The system may determine the size of the SOI from an uncropped, non-zoomed-in image (e.g., a video stream or static image). Based upon the size of the image, the system can determine the optimal resolution for each SOI video stream. This approach minimizes the need for upscaling and downscaling operations, thereby preserving video quality and reducing bandwidth usage.

### TECHNICAL FIELD

Embodiments pertain to selective encoding of video streams. Some embodiments relate to selective encoding of video streams based upon a size of a subject-of-interest in the streams.

### BACKGROUND

The advent of video conferencing technology has revolutionized the way individuals and organizations communicate. With the proliferation of high-speed internet and advancements in digital imaging, video conferencing has become a staple in modern communication, allowing for real-time visual and audio interaction between parties in disparate locations. Intelligent cameras have been integral to this development, offering sophisticated features such as automatic zooming and tracking, high-definition video capture, and multi-stream capabilities. These cameras are often employed in meeting rooms to facilitate group discussions, presentations, and collaborative sessions over platforms such as Microsoft TEAMS®, which have become essential tools for businesses, educational institutions, and personal use.

In the realm of digital video, resolution plays an important role in the quality of the visual experience. High-resolution video streams provide detailed and clear images, which are particularly important in settings where visual information is shared and discussed. However, the demand for high-resolution video comes with increased bandwidth requirements, which can pose challenges in network environments with bandwidth limitations or quotas. As such, the optimization of video resolution in relation to bandwidth consumption has been an area of ongoing technological development, seeking to balance the need for video clarity with the constraints of network resources.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic of a network-based communication system 100 according to some examples of the present disclosure.

FIG. 2 illustrates a schematic 200 of a data flow between a camera and a resolution selector according to some examples of the present disclosure.

FIG. 3 illustrates a flowchart of a method 300 for selectively encoding video streams within a communication system, according to some examples of the present disclosure.

FIG. 4 is a block diagram illustrating an example of a machine upon which one or more embodiments may be implemented.

### DETAILED DESCRIPTION

In some video conferencing setups, such as conference room setups, a camera may provide individual video streams for various subjects of interest (SOIs). Example SOIs may include one or more participants (e.g., in a conference room), whiteboards, physical presentations, physical objects (e.g., models), and the like. Each SOI may be situated at varying distances from the camera and may be of a varying size. This variance in distance and overall size can result in discrepancies in the size of the image of the SOI when streamed to other participants. To maintain uniformity of the resolution of each participant, cameras may digitally zoom in on SOIs and upscale the resulting image. This digital zooming can degrade the resolution of the video stream for the zoomed-in SOI when compared to SOIs that are closer to the camera or bigger and require less zoom.

Each SOI stream is then transmitted at a uniform resolution. These SOI streams may then be independently upscaled and/or downscaled to a different resolution based upon a composition of the communication session, client bandwidth and streaming capabilities, and/or other factors. These additional scaling operations may further degrade the image quality. In addition to degrading image quality, these operations may waste bandwidth. For example, if a particular head size of a user is zoomed in such that its resolution is effectively 480 p (640×480), current systems would upscale that to 720 p (1280×720) or even 1080 p (1920×1080) and send that to the communication service. The communication service may then downscale that stream back to 480 p based upon the composition of the communication session, client bandwidth, network congestion, or based upon other factors. Thus, bandwidth between the camera and the communication service is wasted in addition to degrading the image.

Disclosed in some examples, are systems, methods, devices, and machine-readable mediums which solve the problem by optimizing the resolution of video streams at the point of capture based on the object size of the SOI. The system may determine the size of the SOI from an uncropped, non-zoomed-in image (e.g., a video stream or static image). Based upon a determined size of each SOI in the uncropped, non-zoomed in image, the system can determine the optimal resolution for each SOI video stream. This approach minimizes the need for upscaling and downscaling operations, thereby preserving video quality, reducing bandwidth usage, and reducing computing time in upscaling and downscaling.

SOI size may be determined using a number of techniques. The size may be determined from the image itself, such as in examples in which the SOI is a human participant, the system may utilize head size detection to determine a size of a participant's head using the image. One example head size detection algorithm includes a Convolutional Neural Network (CNN) trained to predict the position and scale of heads. SOI size for other objects may be determined similarly, such as using a CNN algorithms trained for recognizing the size and position of each object. In other examples, a distance to the object to the camera may be detected using the pixels in the image itself, Light Detection and Ranging (LiDAR), time-of-flight estimates, and the like. The distance of the object to the camera may then be used along with prespecified SOI sizes based upon the type of SOI. For example, for a person, the distance of the person to the camera along with standardized headsize information may be used to determine a size of the person in the image.

In one embodiment, an intelligent camera equipped with head size detection technology captures a video stream of a meeting room. The camera's software analyzes the uncropped stream to assess the head size of each participant, which correlates to their distance from the camera. Based on this analysis, the system dynamically adjusts the resolution at which each participant's video stream is captured. For example, if a participant is detected to be farther from the camera, resulting in a smaller head size in the video, the system may capture their stream at a lower resolution since high resolution would not enhance the actual quality of the digitally zoomed-in image. Conversely, if a participant moves closer to the camera, the system can increase the resolution of their stream accordingly. While the above example was described for human participants, streams of other SOIs, such as whiteboards, may be similarly scaled.

The disclosed systems may further include a periodic evaluation mechanism that reassesses the optimal resolution for each SOI's video stream at set intervals or when a change in the SOI's size (e.g., if the SOI changes position-such as a distance to the camera) is detected. This ensures that the video quality is maintained throughout the meeting, even as participants and other objects move within the room. Additionally, the system can communicate with the video conferencing platform to ensure that clients receive the stream at the optimal resolution for their bandwidth capabilities, thus avoiding unnecessary downscaling that could degrade the video quality.

The technical problem addressed by the present disclosure relates to the inefficient use of bandwidth and the degradation of video quality in video conferencing systems due to the need to digitally zoom in on subjects of interest such as participants who are situated at varying distances from the camera. This problem is exacerbated when the video conferencing system requires the transmission of all SOI streams at a uniform high resolution, regardless of the actual distance of participants from the camera, leading to the streaming of lower quality video at a higher resolution and the wasteful consumption of bandwidth. The technical solution provided by the disclosure involves systems, methods, devices, and machine-readable mediums that optimize the resolution of video streams at the point of capture based on the size of the SOI. By employing size detection (such as head size detection) from an uncropped, non-zoomed-in image, the system dynamically adjusts the resolution for each SOI's video stream, thereby minimizing the need for upscaling and downscaling operations. This solution not only preserves the quality of the video streams but also reduces the bandwidth required for transmitting video streams in a video conferencing environment.

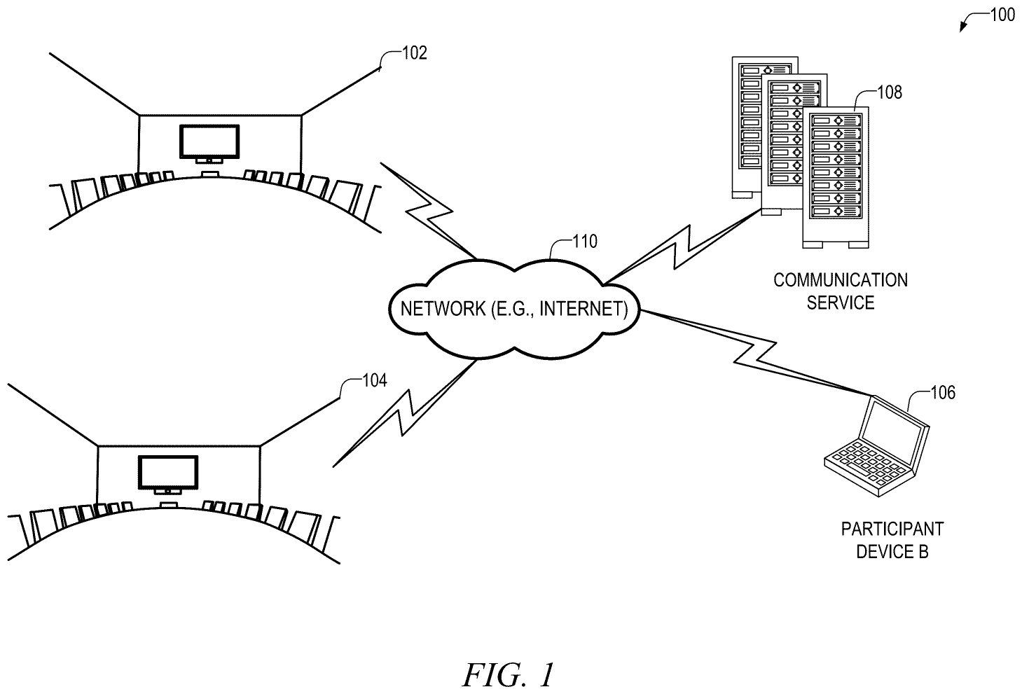

FIG. 1 illustrates a schematic of a network-based communication system 100 according to some examples of the present disclosure. The system includes conference rooms 102 and 104, which may house one or more participants engaging in a network-based communication session, such as an online meeting. These conference rooms may be equipped with dedicated computing devices designed for conference settings, along with specialized video and audio equipment, including video cameras, to facilitate the communication session. The conference rooms 102 and 104 are connected, over a network 110, to a network-based communication service 108, which may be a server or a cluster of servers that provide various network-based communication functionalities. These functionalities may include one or more of: audio/video streaming and communications; content sharing; compositing of a meeting where multiple video streams are combined to create a unified view for the participants; and the like. The network-based communication service 108 may manage the flow of data between participants and ensure that audio and video streams are synchronized and delivered in real-time. The network-based communication service 108 may also handle tasks such as audio/video streaming, encoding and decoding of media, managing participant connections, and facilitating interactive features like screen sharing, virtual whiteboards, and file sharing.

The communication between the conference rooms 102 and 104 and the network-based communication service 108 occurs over a network 110 (such as the Internet), which provides for data transmission between the components of FIG. 1. This network connectivity enables participants to join the communication session from geographically dispersed locations, ensuring that distance is not a barrier to collaboration and interaction. In addition to the dedicated devices in conference rooms 102 and 104, other participants may join the online meeting using their own participant devices such as participant device 106, which can range from personal computers and laptops to tablets and smartphones. These participant devices may be equipped with cameras, microphones, and speakers to allow individuals to contribute to the online meeting effectively.

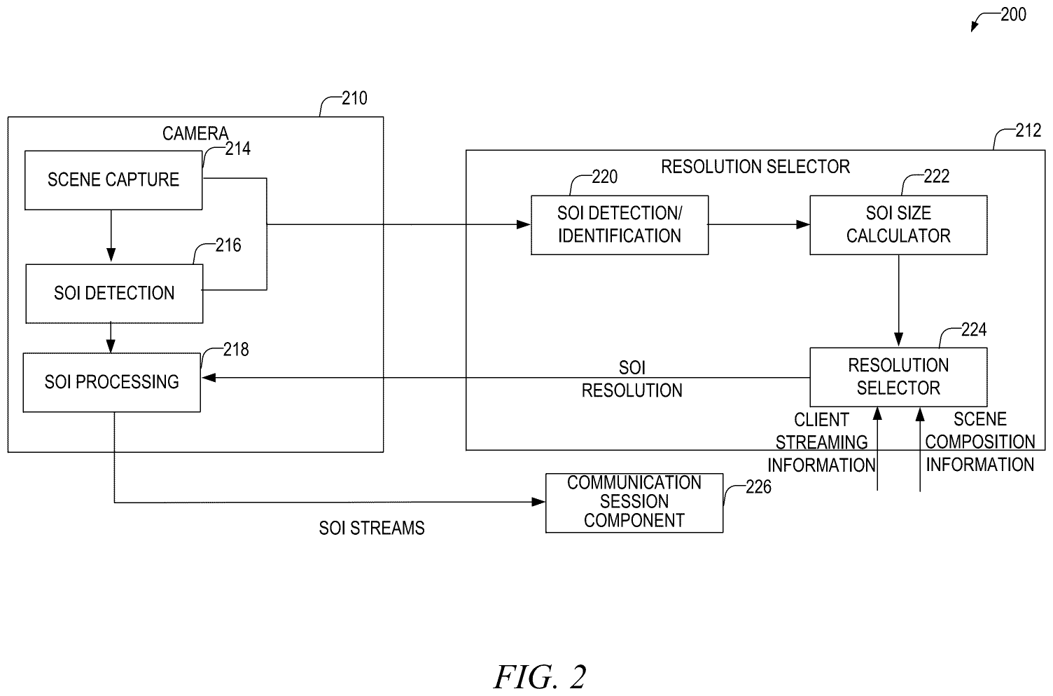

FIG. 2 illustrates a schematic 200 of a data flow between a camera 210 and a resolution selector 212 according to some examples of the present disclosure. The camera 210, may be within a conference room such as those depicted in FIG. 1 or a participant computing device, such as participant computing device B 106. Camera 210 captures a comprehensive view of the conference environment using the scene capture component 214 which is designed to acquire high-fidelity images or video of the room, typically at a high initial resolution such as 4K, to ensure that all details within the scene are preserved.

Once the scene is captured, the process of identifying subjects of interest (SOIs) within the scene is initiated. This can be accomplished either by the SOI detection component 216 within the camera 210 or by the SOI detection and identification component 220 within the resolution selector 212. The SOI detection component 216 and/or the SOI detection and identification component 220 utilize advanced image processing algorithms to scan the captured scene and identify potential SOIs based on predefined criteria such as movement, shape, or facial recognition markers. In some examples detecting SOIs may be based upon machine learning models such as convolutional neural networks (CNNs), to analyze the scene and pinpoint the SOIs. In some examples, both camera 210 and resolution selector 212 may detect SOIs. For example, the camera 210 may provide preliminary SOI detection data that is then refined by the SOI detection and identification component 220 to enhance the accuracy of SOI identification by cross-referencing with additional data sources or applying more complex algorithms.

Following the detection and identification of SOIs, the size calculation component 222 of the resolution selector 212 computes the distance of each SOI from the camera 210. This computation may involve analyzing the relative size of the SOI within the scene, applying geometric transformations, or utilizing depth-sensing technologies such as time-of-flight or stereo vision. In some examples, this may be based upon a head detection algorithm that then is cross-referenced to typical head-sizes. The calculated size may be used to determine optimal framing for each SOI, which includes calculating the ideal zoom level to ensure that each SOI is appropriately focused and framed within the video stream.

The resolution selector 224 determines a suitable encoding resolution for each SOI stream based upon the size determined by size calculation component 222. This decision-making process considers not only the size and framing of the SOIs but may also factor in the resolution capabilities of the receiving client devices, the overall compositional layout of the video conference as dictated by the communication session, and the current network conditions to ensure efficient bandwidth utilization. The scene composition information may be a size of the stream that is used in the scene. For instance, even if the size data and client capabilities suggest a high-resolution stream is possible, a lower resolution may be sufficient if the session's layout is primarily focused on screen sharing, where the video stream occupies minimal screen space. In some examples, the resolution selector 224 may utilize a prespecified table with sizes and resolutions. In examples in which the client streaming information and scene composition information are utilized, the resolution selector 224 may utilize the lowest resolution of: the client capabilities, the scene composition, and the resolution indicated by the size. In still other examples a neural network machine-learning algorithm may utilize these inputs to produce an optimal, machine-learned output based upon supervised training data sets. In yet other examples, if-then statements and/or decision trees or forests may be utilized.

The selected resolution for each SOI stream is then communicated back to the camera 210, where the SOI processing component 218 encodes the video streams accordingly. This component is responsible for dynamically adjusting the encoding parameters, possibly including compression ratios, frame rates, and color depth, to match the resolution specified by the resolution selector 224. Finally, the individually encoded SOI streams are routed to the communication session component 226, which manages the communication session for the communication service. This component orchestrates the multiplexing of the SOI streams, synchronizes audio with video, and manages the distribution of the streams to the client devices. It ensures that each participant receives a video stream that is optimized for their device's display capabilities and current network bandwidth, thereby enhancing the overall quality of the online conferencing experience.

The resolution selector 212, camera 210, and communication session component 226 may be on a same computing device or different computing devices. For example, the resolution selector 212 may be part of the network-based communication service along with the communication session component 226. In some examples, the resolution selector 212 may be part of a same device as the camera 210.

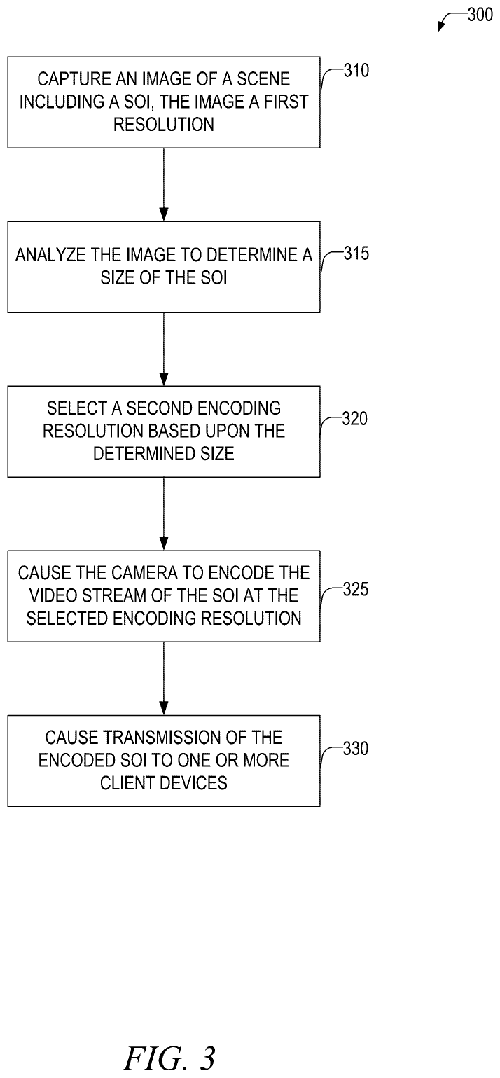

FIG. 3 illustrates a flowchart of a method 300 for selectively encoding video streams within a communication system, according to some examples of the present disclosure. At operation 310, a camera captures an image of a scene. The image may include at least one subject of interest (SOI), such as a participant in a video conference. The image may be encoded at a first encoding resolution, such as a 1080 p or 4K resolution, to ensure comprehensive capture of the scene's details for subsequent analysis. In some examples, the SOI may be detected by the camera or by the system that determines an optimal resolution, such as resolution selector 212 of FIG. 2.

In operation 315, a processor, which is in communication with the camera, analyzes the captured image to ascertain the size of the SOI. For example, algorithms that utilize machine-learning models such as a Convolutional Neural Network (CNN) or variations thereof may be used to determine the size of the SOI. In examples in which the SOI is a participant, the dedicated stream of the participant may be a stream of their head or head and shoulders. In these examples, a headsize algorithm based upon a CNN may be used to determine a headsize of the participant, and a table that maps a headsize or range of headsizes to appropriate resolutions may be used. In examples in which the SOI is an object, a CNN may be used to determine the boundaries and size of the object along with a prespecified table that maps object sizes to appropriate resolutions.

Following the size estimation, operation 320 involves the processor selecting an optimal second encoding resolution for the SOI's video stream. In some examples, the SOI video stream may be a dedicated video stream that is focused on and centers the SOI in the video stream. This selection may be made based upon the size data, where a lower resolution is chosen for smaller SOIs (e.g., those positioned further from the camera) to conserve bandwidth, and a higher resolution is chosen for closer SOIs to preserve detail and clarity.

At operation 325 the camera is caused to encode the SOI's video stream at the selected second encoding resolution. For example, the camera may be instructed by a resolution selection component, such as resolution selector 212 on the appropriate resolution. At operation 330, the encoded video stream is caused to be transmitted to the client devices engaged in the communication session. For example, by instructing the communication service to transmit the streams to one or more client devices participating in the network-based communication session.

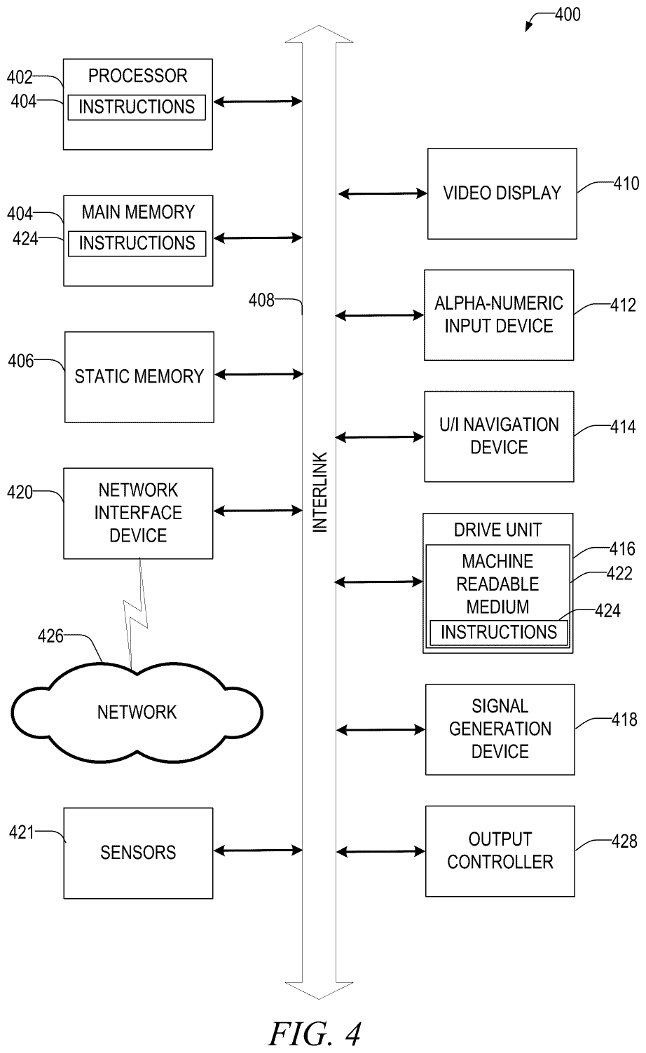

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 400 may be configured to be one of the communication servers of network-based communication service 108, participant device 106, meeting room devices such as for conference rooms 102 and 104, camera 210, and/or resolution selector 212. Machine 400 may be configured to perform the method 300 of FIG. 3.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

### Other Notes and Examples

Example 1 is a method for selectively encoding video streams in a communication system, comprising: capturing by a camera, during a communication session, an image of a scene including a subject of interest (SOI), the image being encoded in a first encoding resolution; analyzing, by a processor in communication with the camera, the captured image encoded in the first encoding resolution to determine a size of the SOI; selecting, by the processor, a second encoding resolution, different than the first encoding resolution, for a video stream of the SOI based on the determined size, wherein a lower encoding resolution is selected for SOIs with a smaller determined size and a higher encoding resolution is selected for SOIs with a higher determined size; causing the camera to encode and transmit the video stream of the SOI at the selected encoding resolution; and causing transmission, by the communication system, of the encoded video stream of the SOI to one or more client devices participating in the communication session.

In Example 2, the subject matter of Example 1 includes, wherein the SOI is a human face.

In Example 3, the subject matter of Example 2 includes, wherein analyzing, by the processor in communication with the camera, the captured image to determine the size of the SOI comprises using a facial recognition algorithm to determine a size of the human face.

In Example 4, the subject matter of Example 3 includes, wherein using the facial recognition algorithms to determine the size of the human face comprises using a lookup table correlating head sizes to sizes for determining the second encoding resolution.

In Example 5, the subject matter of Examples 1-4 includes, periodically re-analyzing the captured image to determine any change in the size of the SOI from the camera and adjusting the encoding resolution accordingly.

In Example 6, the subject matter of Examples 1-5 includes, wherein the communication session is a video conference session.

In Example 7, the subject matter of Examples 1-6 includes, wherein selecting, by the processor, the second encoding resolution, different than the first encoding resolution, for the video stream of the SOI based on the determined size comprises selecting the second encoding resolution also based upon a composited scene sent to the one or more client devices.

In Example 8, the subject matter of Examples 1-7 includes, wherein the scene includes a second SOI, and the method further comprises encoding the second SOI at a third resolution selected based on the determined size of the second SOI from the camera.

In Example 9, the subject matter of Examples 1-8 includes, determining the subject of interest in the image based upon a convolutional neural network (CNN) trained to detect a particular type of object.

Example 10 is a system for selectively encoding video streams in a communication system, comprising: one or more hardware processors configured to perform operations comprising: capturing by a camera, during a communication session, an image of a scene including a subject of interest (SOI), the image being encoded in a first encoding resolution; analyzing the captured image encoded in the first encoding resolution to determine a size of the SOI; selecting a second encoding resolution, different than the first encoding resolution, for a video stream of the SOI based on the determined size, wherein a lower encoding resolution is selected for SOIs with a smaller determined size and a higher encoding resolution is selected for SOIs with a higher determined size; causing the camera to encode and transmit the video stream of the SOI at the selected encoding resolution; and causing transmission, by the communication system, of the encoded video stream of the SOI to one or more client devices participating in the communication session.

In Example 11, the subject matter of Example 10 includes, wherein the SOI is a human face.

In Example 12, the subject matter of Example 11 includes, wherein the operations of analyzing, by the processor in communication with the camera, the captured image to determine the size of the SOI comprises using a facial recognition algorithm to determine a size of the human face.

In Example 13, the subject matter of Example 12 includes, wherein the operations of using the facial recognition algorithms to determine the size of the human face comprises using a lookup table correlating head sizes to sizes for determining the second encoding resolution.

In Example 14, the subject matter of Examples 10-13 includes, wherein the operations further comprise periodically re-analyzing the captured image to determine any change in the size of the SOI from the camera and adjusting the encoding resolution accordingly.

In Example 15, the subject matter of Examples 10-14 includes, wherein the communication session is a video conference session.

In Example 16, the subject matter of Examples 10-15 includes, wherein the operations of selecting the second encoding resolution, different than the first encoding resolution, for the video stream of the SOI based on the determined size comprises selecting the second encoding resolution also based upon a composited scene sent to the one or more client devices.

In Example 17, the subject matter of Examples 10-16 includes, wherein the scene includes a second SOI, and the operations further comprises encoding the second SOI at a third resolution selected based on the determined size of the second SOI from the camera.

In Example 18, the subject matter of Examples 10-17 includes, wherein the operations further comprise determining the subject of interest in the image based upon a convolutional neural network (CNN) trained to detect a particular type of object.

Example 19 is a machine-readable storage device, storing instructions for selectively encoding video streams in a communication system, the instructions when executed, causing one or more hardware processors to perform operations comprising: capturing by a camera, during a communication session, an image of a scene including a subject of interest (SOI), the image being encoded in a first encoding resolution; analyzing the captured image encoded in the first encoding resolution to determine a size of the SOI; selecting a second encoding resolution, different than the first encoding resolution, for a video stream of the SOI based on the determined size, wherein a lower encoding resolution is selected for SOIs with a smaller determined size and a higher encoding resolution is selected for SOIs with a higher determined size; causing the camera to encode and transmit the video stream of the SOI at the selected encoding resolution; and causing transmission, by the communication system, of the encoded video stream of the SOI to one or more client devices participating in the communication session.

In Example 20, the subject matter of Example 19 includes, wherein the SOI is a human face.

In Example 21, the subject matter of Example 20 includes, wherein the operations of analyzing, by the processor in communication with the camera, the captured image to determine the size of the SOI comprises using a facial recognition algorithm to determine a size of the human face.

In Example 22, the subject matter of Example 21 includes, wherein the operations of using the facial recognition algorithms to determine the size of the human face comprises using a lookup table correlating head sizes to sizes for determining the second encoding resolution.

In Example 23, the subject matter of Examples 19-22 includes, wherein the operations further comprise periodically re-analyzing the captured image to determine any change in the size of the SOI from the camera and adjusting the encoding resolution accordingly.

In Example 24, the subject matter of Examples 19-23 includes, wherein the communication session is a video conference session.

In Example 25, the subject matter of Examples 19-24 includes, wherein the operations of selecting the second encoding resolution, different than the first encoding resolution, for the video stream of the SOI based on the determined size comprises selecting the second encoding resolution also based upon a composited scene sent to the one or more client devices.

In Example 26, the subject matter of Examples 19-25 includes, wherein the scene includes a second SOI, and the operations further comprises encoding the second SOI at a third resolution selected based on the determined size of the second SOI from the camera.

In Example 27, the subject matter of Examples 19-26 includes, wherein the operations further comprise determining the subject of interest in the image based upon a convolutional neural network (CNN) trained to detect a particular type of object.

Example 28 is at least one machine-readable medium including instructions that, when executed by processing circuitry, cause the processing circuitry to perform operations to implement of any of Examples 1-27.

Example 29 is an apparatus comprising means to implement of any of Examples 1-27.

Example 30 is a system to implement of any of Examples 1-27.

Example 31 is a method to implement of any of Examples 1-27.

What is claimed is:

1. A method for selectively encoding video streams in a communication system, comprising:
capturing by a camera, during a communication session, an image of a scene including a subject of interest (SOI), the image being encoded in a first encoding resolution;
analyzing, by a processor in communication with the camera, the captured image encoded in the first encoding resolution to determine a size of the SOI;
selecting, by the processor, a second encoding resolution, different than the first encoding resolution, for a video stream of the SOI based on the determined size, wherein a lower encoding resolution is selected for SOIs with a smaller determined size and a higher encoding resolution is selected for SOIs with a higher determined size;
causing the camera to encode and transmit the video stream of the SOI at the selected encoding resolution; and
causing transmission, by the communication system, of the encoded video stream of the SOI to one or more client devices participating in the communication session.

2. The method of claim 1, wherein the SOI is a human face.

3. The method of claim 2, wherein analyzing, by the processor in communication with the camera, the captured image to determine the size of the SOI comprises using a facial recognition algorithm to determine a size of the human face.

4. The method of claim 3, wherein using the facial recognition algorithms to determine the size of the human face comprises using a lookup table correlating head sizes to sizes for determining the second encoding resolution.

5. The method of claim 1, further comprising periodically re-analyzing the captured image to determine any change in the size of the SOI from the camera and adjusting the encoding resolution accordingly.

6. The method of claim 1, wherein the communication session is a video conference session.

7. The method of claim 1, wherein selecting, by the processor, the second encoding resolution, different than the first encoding resolution, for the video stream of the SOI based on the determined size comprises selecting the second encoding resolution also based upon a composited scene sent to the one or more client devices.

8. The method of claim 1, wherein the scene includes a second SOI, and the method further comprises encoding the second SOI at a third resolution selected based on the determined size of the second SOI from the camera.

9. The method of claim 1, further comprising determining the subject of interest in the image based upon a convolutional neural network (CNN) trained to detect a particular type of object.

10. A system for selectively encoding video streams in a communication system, comprising:
one or more hardware processors configured to perform operations comprising:
capturing by a camera, during a communication session, an image of a scene including a subject of interest (SOI), the image being encoded in a first encoding resolution;
analyzing the captured image encoded in the first encoding resolution to determine a size of the SOI;
selecting a second encoding resolution, different than the first encoding resolution, for a video stream of the SOI based on the determined size, wherein a lower encoding resolution is selected for SOIs with a smaller determined size and a higher encoding resolution is selected for SOIs with a higher determined size;
causing the camera to encode and transmit the video stream of the SOI at the selected encoding resolution; and
causing transmission, by the communication system, of the encoded video stream of the SOI to one or more client devices participating in the communication session.

11. The system of claim 10, wherein the SOI is a human face.

12. The system of claim 11, wherein the operations of analyzing, by the processor in communication with the camera, the captured image to determine the size of the SOI comprises using a facial recognition algorithm to determine a size of the human face.

13. The system of claim 12, wherein the operations of using the facial recognition algorithms to determine the size of the human face comprises using a lookup table correlating head sizes to sizes for determining the second encoding resolution.

14. The system of claim 10, wherein the operations further comprise periodically re-analyzing the captured image to determine any change in the size of the SOI from the camera and adjusting the encoding resolution accordingly.

15. The system of claim 10, wherein the communication session is a video conference session.

16. The system of claim 10, wherein the operations of selecting the second encoding resolution, different than the first encoding resolution, for the video stream of the SOI based on the determined size comprises selecting the second encoding resolution also based upon a composited scene sent to the one or more client devices.

17. The system of claim 10, wherein the scene includes a second SOI, and the operations further comprises encoding the second SOI at a third resolution selected based on the determined size of the second SOI from the camera.

18. The system of claim 10, wherein the operations further comprise determining the subject of interest in the image based upon a convolutional neural network (CNN) trained to detect a particular type of object.

19. A machine-readable storage device, storing instructions for selectively encoding video streams in a communication system, the instructions when executed, causing one or more hardware processors to perform operations comprising:
capturing by a camera, during a communication session, an image of a scene including a subject of interest (SOI), the image being encoded in a first encoding resolution;
analyzing the captured image encoded in the first encoding resolution to determine a size of the SOI;
selecting a second encoding resolution, different than the first encoding resolution, for a video stream of the SOI based on the determined size, wherein a lower encoding resolution is selected for SOIs with a smaller determined size and a higher encoding resolution is selected for SOIs with a higher determined size;
causing the camera to encode and transmit the video stream of the SOI at the selected encoding resolution; and
causing transmission, by the communication system, of the encoded video stream of the SOI to one or more client devices participating in the communication session.

20. The machine-readable storage device of claim 19, wherein the SOI is a human face.
